(19) United States
(12) Patent Application Publication
(10) Pub. No.: US 2004/0162710 A1
(43) Pub. Date: Aug. 19, 2004

(54) System and method for assessing mold risk propensity in a structure

(76) Inventor: Lawrence A. Schwartz, Buffalo Grove, IL (US)

Correspondence Address: Monique A. Morneault, Esq., Wallenstein Wagner & Rockey, Ltd., 311 South Wacker Drive, 53rd Floor, Chicago, IL, 60606-6630, US

(21) Appl. No.: 10/779,994

(22) Filed: Feb. 17, 2004

Related U.S. Application Data
(60) Provisional application No. 60/447,584, filed on Feb. 14, 2003.

(51) Int. Cl. G06F 17/10

(52) U.S. Cl. 703/2

(57) ABSTRACT

A method and system for assessing a structure's propensity to contain mold or cultivate mold growth. The method includes providing an inspection form having a plurality of structure characteristics to be evaluated. Receiving and utilizing the completed inspection form to calculate a mold risk score.

### RELATED APPLICATION

The present application claims priority to U.S. Provisional patent application Serial No. 60/447,584 entitled “System and Method for Assessing Mold Risk Propensity in a Building,” filed Feb. 14, 2003, the contents of which are expressly incorporated herein by reference.

### TECHNICAL FIELD

This invention relates generally to the field of structure inspection. More specifically, the present invention is related to inspecting and assessing a building's propensity to contain and/or generate mold.

### BACKGROUND OF THE INVENTION

Building inspections are designed to ensure the inhabitability of a premises for human occupation. Building inspections generally consider the type and purpose of the structure, e.g., commercial, residential family, etc., and many of the inspected areas concern physical characteristics of the building, e.g., roofing, lighting, heating, plumbing, foundation, electrical wiring, etc. Other building features that may be inspected, which are somewhat less directly related to the building's physical features, include the presence of radon and the geographical location and surrounding terrain on which the building is situated. The condition of these features is assessed to determine if repair or replacement is needed.

Another building characteristic that has been of major concern in recent years involves mold and/or the propensity of mold to grow in the building. In the past few years, the adverse effects of molds on people and animals have become increasingly known. Although not all molds are harmful, some molds often found in homes may cause allergic or immuno responses while other molds may produce or carry toxins that may cause pathogenic effects in people and animals. Mycotoxins are chemical toxins on the surface of spores and other mold materials that can adversely affect a person's health. Some of these toxins may cause wheezing, dizziness, headaches, pulmonary hemorrhaging, and cancer.

Molds consume organic material and recycle the material back into the environment. Although molds cannot digest food without water, many molds can start and continue to grow without water because they possess an ability to prosper solely on elevated humidity levels, e.g., above 60%. While mold cells may go dormant due to the lack of water, the mold's spores do not. The spores are the principal carriers of the toxins and are extremely difficult to destroy. Various cleaning solutions, e.g., water and bleach, may effectively kill the mold cells, but the spores will not die and the mold will begin growing again if the area becomes wet or the humidity level rises.

Once detected, mold is extremely difficult to remove. Although mold probably exists in most buildings, it is preferable to prevent or minimize the mold's growth to a low level. Two factors controlling mold growth include minimizing the presence of moisture and ensuring proper ventilation throughout the building. There are many ways for moisture to get into a building. Some of these ways include inadequate roofing construction or wear, ill-fitting or improperly pitched gutters, unfavorable land topography surrounding the building, and foundation type and imperfections.

Because the presence of mold can have a disastrous effect on a building's inhabitability and monetary value, the control and reduction of hazardous molds has become a high-level priority. To this end, there is a need for a reliable system or method to assess a building's propensity to foster mold growth.

The present invention is provided to solve these and other problems.

### SUMMARY OF THE INVENTION

One embodiment of the present invention is directed to a method for assessing a building's propensity to foster mold growth. The method comprises providing an inspection form. The completed inspection form is received and a calculator determines a mold risk score in response to graded variables recorded on the inspection form.

A further aspect of the above embodiment includes providing an action item list to reduce the mold risk score in response to the calculated mold risk score.

Another aspect of the present invention is a system for assessing a building's propensity to mold growth. The system comprises a base module and a remote module being operably connected to the base module. An inspection form includes a plurality of building characteristics utilized during inspection of the building. The inspection form is accessible to the base and remote modules and can be transmitted there between. A calculator operably connected to the base module utilizes the completed inspection form to calculate a mold risk score. The mold risk score can be accessed from the system.

An object of the present invention is to provide a mechanism for evaluating a building's propensity to acquire mold or foster mold growth.

Another object of the present invention is to provide a suggestive course of action to reduce the risk of mold growth to an acceptable level.

These and other aspects and attributes of the present invention will be discussed with reference to the following drawings and accompanying specification.

### BRIEF DESCRIPTION OF THE DRAWINGS

FIG. 1 is a block diagram of one embodiment of the present invention;

FIG. 2 is a diagram depicting one embodiment of an inspection form;

FIG. 3 is diagram depicting a range of mold risk scores;

FIG. 4 is a diagram depicting a solution generated in response to a calculated mold risk score performed on a completed inspection form; and,

FIG. 5 is a diagram depicting one embodiment of the calculation of the mold risk score.

### DETAILED DESCRIPTION

While this invention is susceptible to embodiments in many different forms, there are shown in the drawings and will herein be described in detail preferred embodiments of the invention with the understanding that the present disclosures are to be considered as exemplifications of the principles of the invention and are not intended to limit the broad aspects of the invention to the embodiments illustrated.

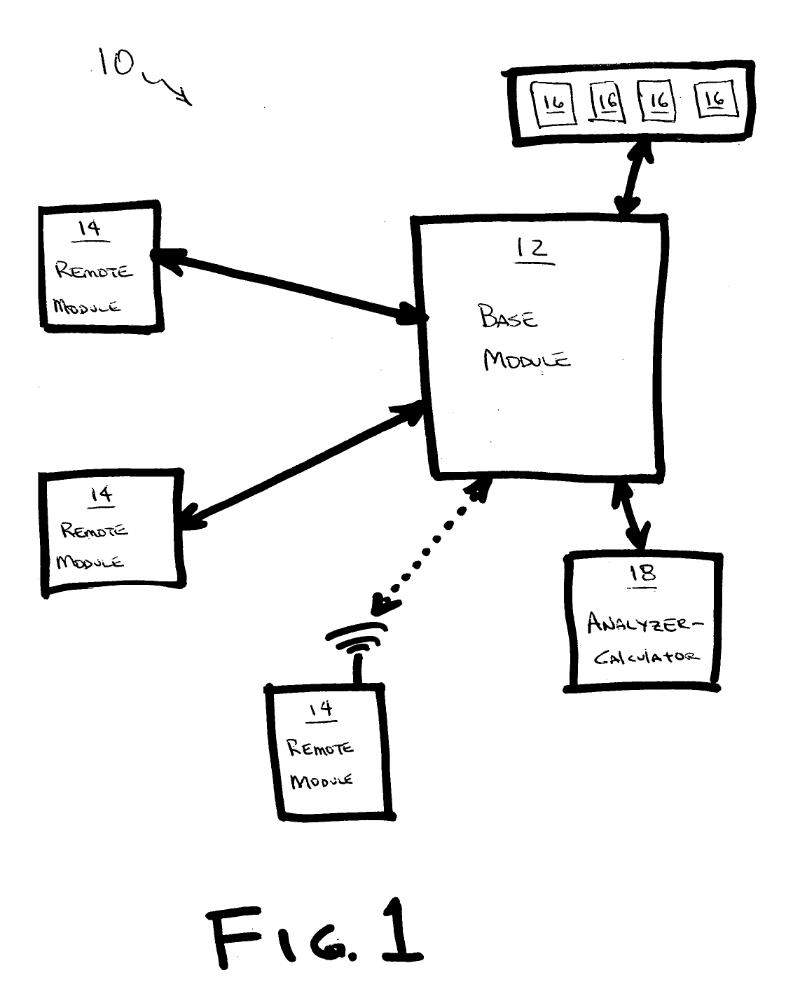

Referring to the drawings in detail, wherein similar reference characters designate corresponding parts throughout the several views, one embodiment of the present invention shown in FIG. 1 is a system 10 for assessing a building's propensity to contain mold or foster mold growth. The system 10 includes a base module 12 and a remote module 14 being operably connected to each other. The base module 12 provides responses to requests by the remote module 14. Preferably, the base 12 and remote 14 modules are configured in a server-client architecture; however, the base 12 and remote 14 modules may reside on a single device or medium such as a hand-held computer, personal digital assistant (PDA), controller or program.

In determining a building's mold risk propensity, a visual inspection is often performed on the building being analyzed. The inspection involves an appropriate amount of variables or components. An inspection form 16 includes a plurality of variables, e.g., sectors, utilized to facilitate an evaluation and assessment of the building's propensity to contain mold or cultivate mold growth. Such sectors may include, but are not limited to, interior, exterior, roofing, building envelope, attic, foundation drainage, plumbing, foundation type, and HVAC system.

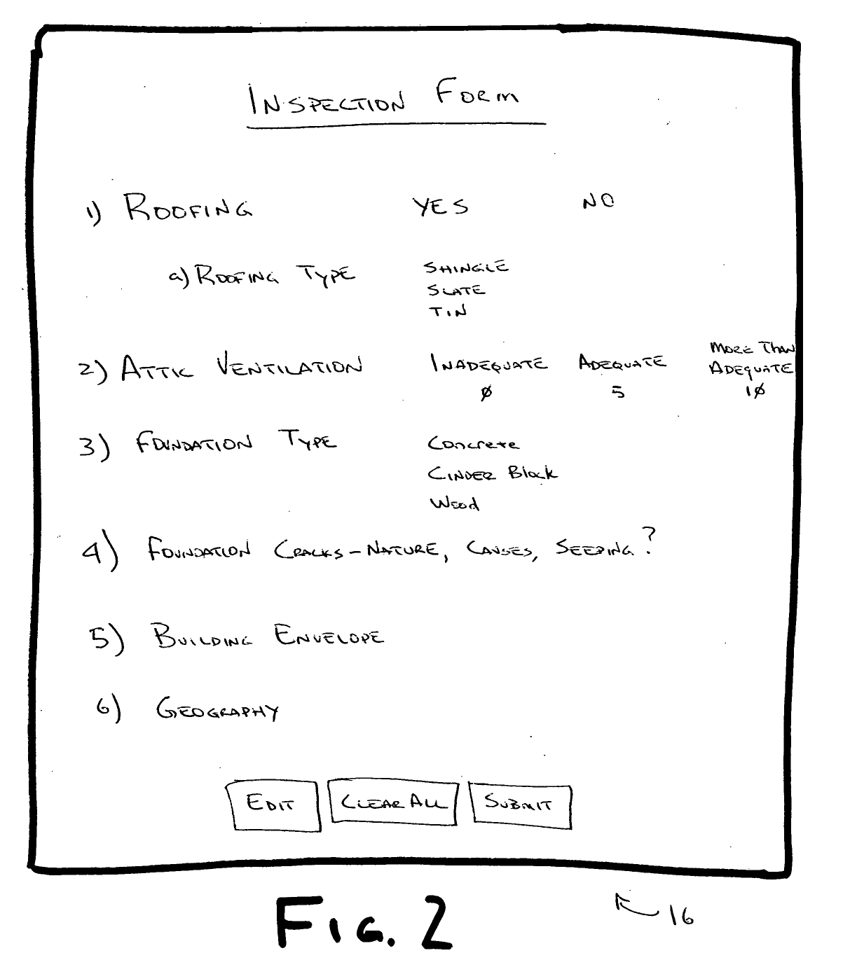

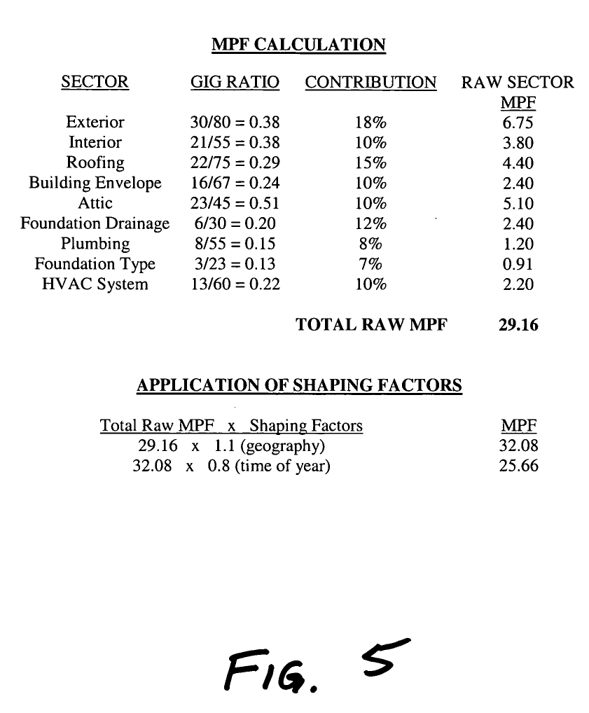

Within each sector, a plurality of specific inspection details may be included. For instance, the exterior sector comprises specific inspection details such as topography, grades at the building's foundation, plantings near and around the building, gutters, and downspouts. Specific inspection details of the interior section include visual mold, relative humidity readings, moisture meter readings near plumbing drains, bath surrounds, exterior walls, and water stains, as well as fireplace and skylight locations. The roofing sector includes roof type and style, degree of pitch, surface material and condition, condition and existence of flashing and eaves, and the quality and quantity of vents. The building envelope sector includes specific inspection details directed to type and condition of siding, flashing and wall penetrations, caulking, interior wall material, insulation type, sheathing, and vapor retarders in the walls. Details for the attic comprise style and design, roof structure type, placement and square-feet of venting, amount of blocked vents, presence and scope of visual mold, amount and condition of insulation, and the presence of vapor retarder on the attic floor. The foundation drainage sector may include the presence of a perimeter drainage system and drain tiles, visual and operating condition of a sump pump, the presence of efflorescence on foundation walls, mold presence on basement or cellar walls, water stains on basement walls, moldy odors in the basement, thermographic analysis on basement walls, and the presence of a pit-only sump pump system. The plumbing system includes specific inspection details such as supply line material, drain line material, oxidized pipe junctions, electrolytic damage, visual age and condition, leaky trap, drains, and faucets, and moisture near bath surrounds as determined by a moisture meter. Specific inspection details for the foundation type comprise crawl space, basement/cellar, slab, composite, visual mold near or on subflooring/joists, and insulation in rim joists. Specific inspection details for the HVAC system sector include type, location, input/discharge, and age of heating system, furnace, and air conditioning, condition and insulation of venting and venting junctions, and humidifiers. An example of various sectors and specific inspection details are shown in FIGS. 2 and 5.

Each specific inspection detail to be observed may be rated on a scale, e.g., 0-5, 0-10, or a fixed basis. The rating points are identified as gigs. The amount of details and gigs may be dependent upon the type of analysis being utilized. For example, additional inspection details and gigs may be implemented with thermographic analysis.

The inspection form 16 is preferably stored on the base module 12 and is accessible to both the base and remote 14 modules. The inspection form is preferably transmitted between the base 12 and remote module 14 via a network, e.g., the Internet. After being utilized during the inspection, the completed form 16 is sent to an analyzer/calculator 18. Once the completed inspection form 16 is utilized by the analyzer/calculator 18 to determine a mold risk score, i.e., final mold propensity factor (MPF).

Calculation of the final MPF includes a determination of a building sector factor. The building sector factor is the ratio of the gigs of specific inspection details scores to the total possible specific inspection detail scores within each sector. A weighted percentage is utilized with the determined building sector factor to obtain a raw sector MPF. The weighted percentage for any sector corresponds to the sector's expected contribution to moisture issues and is subject to adjustment. The sum of the weighted percentages for all sectors utilized in the calculation of the final MPF equals approximately 100%. The raw sector MPF for each sector is the product of the respective building sector factor and its corresponding weighted percentage. The total raw MPF, or raw MPF risk assessment factor, is the sum of the determined raw sector MPFs.

In addition, various shaping factors can be utilized to adjust the total raw MPF. Such shaping factors may be based on the geography near the building being analyzed, the time of year the analysis is being performed, or empirical data gathered with respect to mold growth within a building. The shaping factors can be utilized to adjust the magnitude of the characteristics evaluated by the inspector to reflect the level of attention that should be directed to building characteristics that potentially have a greater effect on a building's propensity to contain mold or foster mold growth.

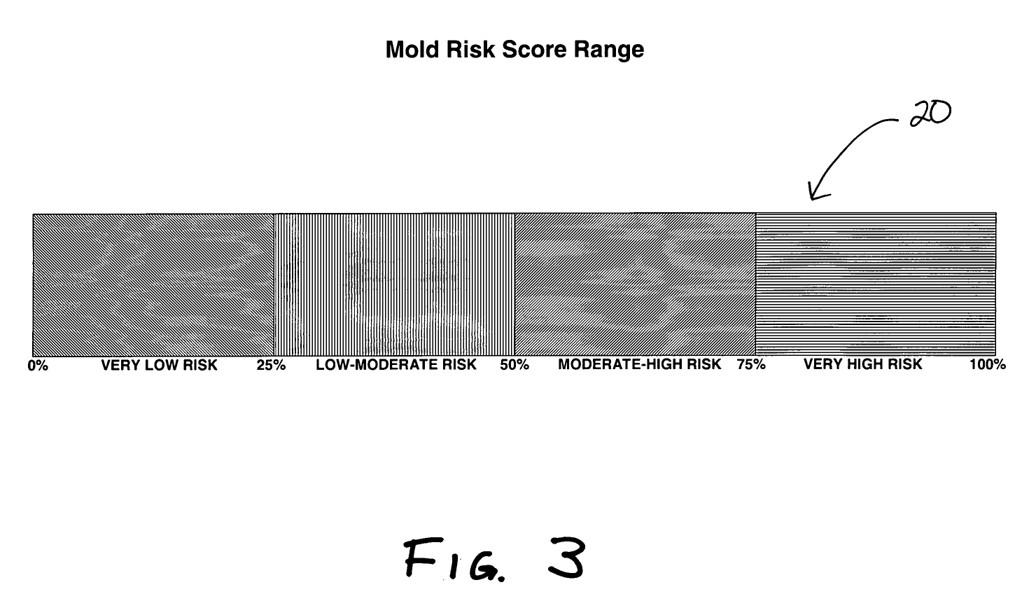

The final MPF score can be considered in determining whether action should be taken to reduce the building's calculated mold propensity risk. Referring to FIG. 3, several levels of probability-ranging from a very low risk to a very high risk—for mold becoming a major issue in the building are established, e.g., low probability (0-25%), moderate probability (25-50%), moderately high probability (50-75%), and high probability (75-100%).

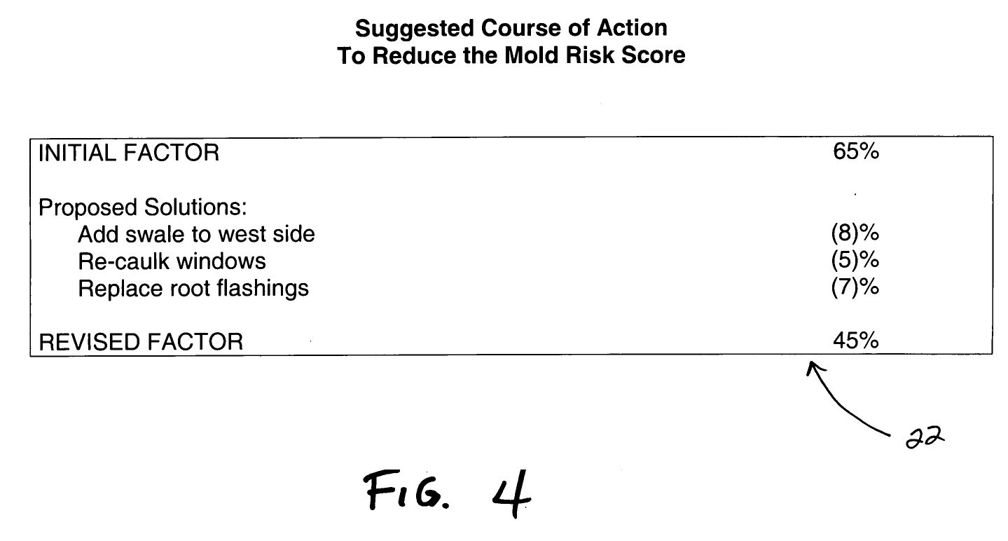

Additionally, if the calculated mold risk score exceeds a predetermined threshold, e.g., 50%, a list of proposed resolutions as shown in FIG. 4 can be provided for suggesting action to reduce the final MPF score. The threshold is adjustable and may be set at different percentages dependent upon the type of building and/or its geographical location. The suggested solution provides steps to be taken to reduce the MPF score and its probable subsequent reduction if the steps are taken. The actions provided to reduce the calculated mold risk score are in response to the MPF score and may be listed in various orders of priority, e.g., economical feasibility, level of potential reduction, complexity of implementation, etc.

To assist with the understanding of the present invention, an exemplification of one embodiment of the present invention is now provided. A request for a building inspection is initiated by an owner, a buyer, a seller, a financial institution, an insurer, a land developer or builder, a government agency, etc. A building inspector requests an appropriate inspection form 16 associated with the type of building to be inspected. The inspector's request can be made via mail, e-mail, facsimile, telephone, communication network, e.g., Internet, etc. Preferably, the inspector utilizes the system's 10 remote module 14 to access the base module 12 wherein a plurality of inspection forms 16 are stored. User access to the system 10 may be restricted by requiring a password, fee, membership, etc. The inspector selects one or more forms 16 having sectors and/or specific inspection details pertaining to the type of building to be inspected, e.g., residential home, commercial warehouse, etc. The selected inspection form 16 is capable of being transmitted to the inspector. Various means of transmitting the inspection form 16 include, but are not limited to, mail, e-mail, facsimile, and file transfer, e.g., downloading to the remote module 14 or a printer.

The inspector utilizes the inspection form 16 and grades each applicable sector and/or specific inspection detail. Various aids and requirements may be utilized to ensure rating reliability. For instance, photographs or dimensions may be provided for use with the inspection form 16 to facilitate the grading of the sector and to ensure grading consistency. Additionally, the inspector may be required to pass a building inspection certification test before being permitted to perform a mold inspection and assessment of a building.

The inspection form 16 can be constructed on a physical material such as paper and capable of being read by a machine, e.g., punched-out holes or darkened ovals utilized in standardized tests and voting booths. Preferably, the inspection form 16 is capable of being placed on a portable PC, personal digital assistant (PDA), or similar device, for convenient use by the inspector. Once the applicable sectors and specific inspection details of the form 16 have been filled out by the inspector, the inspection form 16 is transmitted to the base module 12.

Similar to the transmission of the requested inspection form 16 to the remote module 14, transmission of the completed form can likewise be transmitted to the base module 12 and the calculator 18. The contents of the completed inspection form 16 are processed by the calculator 18. The calculator utilizes the completed inspection form 16 and computes the final MPF. Multiple sectors and specific inspection details are utilized with weighting and scaling factors to determine the final MPF. As discussed above, the type and amount of sectors, details, and shaping factors are adjustable to achieve desired results.

An example of a final MPF calculation is shown in FIG. 5. The sectors analyzed by the inspector are listed in the first column, SECTOR. The building sector factor calculated in the second row, GIG RATIO, is the ratio of the amount of specific inspection detail scores assigned by the inspector to the total possible specific inspection detail scores, e.g., 30 out of 80. Each building sector factor is adjusted by a predetermined weighting factor, e.g., 18%, to achieve a RAW SECTOR MPF, e.g., 6.75. The weighting factor may be utilized to reflect the contribution as a whole of the sector and/or specific inspection details. The individual RAW SECTOR MPFs are added to acquire the TOTAL RAW MPF. Additional shaping factors, e.g., geographical part of the country of which the building is located, may then be applied to the TOTAL RAW MPF to determine the FINAL MPF. The mold risk score can be made available to an entity concerned with the inspection results. Such entities may include an owner, buyer, seller, insurer, financier, governmental department or agency, etc.

Although several inspection characteristics capable of being utilized by the present invention are listed above, it is to be understood that other characteristics may also exist. In addition, the use and amounts of scaling, weighting, and shaping factors are modifiable and capable of being changed remotely before storing within the system. Various compilations of characteristics may be selected or modified for use on the inspection form 16. Alternate characteristic groupings and weighting, scaling, and shaping factors can be easily devised and are to be considered within the scope of the present invention. Such modifications may be based on empirical data and acquired information related to the causes and proliferation of molds in buildings.

It will be understood that the invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

1. A system for assessing a building's propensity to mold growth, the system comprising:
a base module;
a remote module being communicably connected to the base module;
an inspection form accessible to the base and remote modules, the inspection form including a plurality of building characteristics utilized during inspection of the building; and,
a calculator for determining a mold risk score, the calculator being operably connected to the base module and capable of utilizing the inspection form to calculate a mold risk score.

2. The system of claim 1 wherein the building characteristic is selected from the group consisting of interior, exterior, roofing, building envelope, attic, foundation drainage, plumbing, foundation type, and HVAC system.

3. The system of claim 1 further comprising:
an action item list providing suggestive solutions to reduce the mold risk score, the action item list being generated in response to the calculated mold risk score exceeding a predetermined level.

4. For the system of claim 1, a method for assessing a building's propensity to foster mold growth, the method comprising the steps of:
providing the inspection form;
receiving a completed inspection form; and,
calculating a mold risk score in response to the completed inspection form.

5. The method of claim 4 further comprising the step of:
performing a mold growth propensity assessment in response to the calculated mold risk score.

6. The method of claim 4 further comprising the step of:
providing a list of suggested steps to reduce the mold risk score in response to the calculated mold risk score exceeding a predetermined threshold level.

7. A method for evaluating mold growth probability within a structure comprising the steps of:
providing questions over a network regarding the structure and building materials used therein;
receiving answers over the network to the questions; and,
calculating a mold risk score in response to the answers.

8. The method of claim 7 further comprising:
providing the mold risk score over the network.

9. The method of claim 7 further comprising the step of:
performing a mold growth propensity assessment in accordance with the provided inspection form.

10. The method of claim 7 further comprising the step of:
providing a list of suggested steps to reduce the mold risk score in response to the calculated mold risk score exceeding a predetermined threshold level.

11. The method of claim 7 further comprising the steps of:
receiving results of a thermal image of the structure and including the results of the thermal image as a variable in calculating the mold risk score.

12. A medium being readable by a machine or a computer, the medium having a program for a system capable of assessing a structure's propensity to foster mold growth, the medium comprising:
a first segment for providing an inspection form;
a second segment for receiving the completed inspection form; and,
a third segment for calculating a mold risk score in response to the completed inspection form.

13. The medium of claim 12 further comprising:
a fourth segment for providing a list of suggested steps to reduce the mold risk score in response to the calculated mold risk score.
